(19) United States
(12) Patent Application Publication
(10) Pub. No.: US 2007/0115336 A1
(43) Pub. Date: May 24, 2007

(54) Digital ink jet printing process method

(76) Inventors: Victory Hui-Yang Ko, Taipei (TW); Lee Chin-Chang, Taipei (TW)

Correspondence Address: BACON & THOMAS, PLLC, 625 SLATERS LANE, FOURTH FLOOR, ALEXANDRIA, VA, 22314, US

(21) Appl. No.: 10/902,124

(22) Filed: Jul. 30, 2004

(51) Int. Cl. B41J 2/01

(52) U.S. Cl. 347/102

(57) ABSTRACT

A digital ink jet printing process method comprising following procedures: 1. Choose the basic material, 2. Pre-process the basic material, 3. Print out graphics on basic materials directly; and, 4. After process on the surface of basic materials to protect the graphics on the surface of the basic materials; based on the procedures, choose the proper basic material to have the basic material with more variable colors, the graphics, colors are not limited, more saturated colors, better scratch-proof and water-proof; the graphics can stay on basic material longer with good weather fastness and grade in deposit standard.

### BACKGROUND OF THE INVENTION

I. Field of the Invention

This invention relates generally to a digital ink jet printing process method and, more specifically, to a digital ink jet printing process method that offers pre-process and after process methods to print pictures and graphics on the surface of inorganic, organic and metal basic materials for long weather fastness and grade in deposit.

II. Description of the Prior Art

Heretofore, it is known that there are many building materials; the most common ceramic tiles are generally subdivided into two types: single color without graphics and multiple ceramic tiles with different colors to piece up simple patterns.

The production of the multiple ceramic tiles with different colors, traditionally, designers define the size first, then fill the tiles with glaze for desired color, after burning with high temperature, the ceramic tiles can have different colors. The kiln can produce desired colors and patterns, however the color variety is limited and cannot produce full color pattern.

In modern busy society, in order to impress consumers with new products or enterprise's image, except for traditional signs and boards, the new method is to print a whole picture over the exterior over a structure, such as a building, an automobile, a bus or a train. If the pattern is a color picture or painting, the known technology cannot print the full color pattern on the exterior of the ceramic tiles of a building or the body of an automobile.

Current printer technology is very good to produce full color images, however they are limited on paper only; more advanced printer can print on soft materials with special inks, therefore a Swiss company developed an ink-jet printer (Uvjet215-C) that applies UV cable inks, the inks dry right away after the illumination of ultraviolet light, the printer can print on the surface of any materials; however, the adhesion of inks on ceramic tiles or metal is weak, the graphic printed can be seen and cannot be touched, once touched, the pictures will be damaged or flake off.

### SUMMARY OF THE INVENTION

It is therefore a primary object of the invention to provide a digital ink jet printing process method offers a low cost and fast production process.

It is still an object for the invention to provide a digital ink jet printing process method in which any picture or graphics can be printed on the basic materials.

It is still another object for the invention to provide a digital ink jet printing process method in which offers digital full color printing process.

In order to achieve the objective set forth, a digital ink jet printing process method in accordance with the present invention comprises following procedures:
1. Choose the basic material;
2. Pre-process the basic material, the pre-processes include: cleaning, drying, preparation material covering, baking temperature for covering preparation material, cooling down, protective coating spraying, standing by, baking, cooling down, surface coarse process, cleaning, drying;
3. Print out graphics with UV printer, print out graphics on basic materials directly; and
4. After process on the surface of basic materials, the after processes include: protective coating spraying, standing by, baking, and cooling down to protect the graphics on the basic materials.

Based on the procedures described above, choose the proper basic material to have the basic material with more variable colors, the graphics, colors are not limited more saturated colors, better scratch-proof and water-proof; the graphics can stay on basic material longer with good weather fastness and grade in deposit standard.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a flow chart of the present invention;

FIG. 2 is another flow chart of the present invention.

### DESCRIPTION OF THE PREFERRED EMBODIMENT

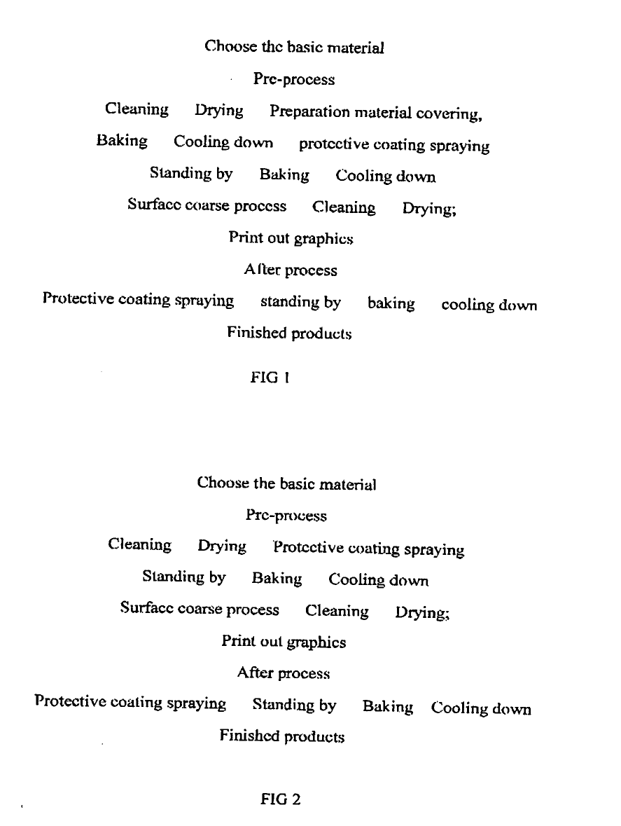

The basic materials can apply to the present invention are subdivided into three categories: inorganic, organic and metal; based on different basic materials, the present invention has different process methods, referring to FIG. 1, the present invention includes following procedures:
1. Choose the basic material, choose the inorganic such as stone, ceramic tiles;
2. Pre-process the basic material, the pre-processes include: cleaning, drying, preparation material covering, baking temperature for covering preparation material, cooling down, protective coating spraying, standing by, baking, cooling down, surface coarse process, cleaning, drying;
3. Print out graphics with UV printer, print out graphics on basic materials directly; and
4. After process on the surface of basic materials, the after processes include: protective coating spraying, standing by, baking, and cooling down to protect the graphics on the basic materials.

The manufacturing of the inorganic material, ceramic tiles for example, is to clean first, and dry the ceramic tiles, after the drying, spray the preparation covering material, then bake the ceramic tiles at 80° C. for twenty minutes to offer the temperature for the preparation covering material; after the cooling, spray the protective coating for 25˜50μ, then stand by for 10 minutes, bake 20 minutes at 160° C., after cooling down, the surface is been coarse with sand paper or sands, the coarse ceramic tiles are cleaned, dried and finished the pre-process.

The preparation material of the pre-process can increase the adhesion between the basic material and the graphics; the protective coating is heat-condense resin, such as phenol resin, alcohol acid resin, polyester resin, amino formic acid ester resin, vinyl resin, propylene acid resin or silicon resin with mineral, the heat-condense resin can increase the scratch-proof of the surface; the coarse process also increases the adhesion surface area of the ceramic tiles.

The UV printer can print on those pre-processed ceramic tiles, the UV printer applies UV curable ink, the ink dries right after the illumination of ultraviolet light, the ink can print on any material; the UV printer prints graphics directly on the surface of the ceramic tiles.

By this time, the graphics and colors on the ceramic tiles are complete, in order to enhance the scratch-proof and weather fastness, after processes are needed, these processes include spraying of protective coating for 25˜50μ, then stand by for 10 minutes, then bake 20 minutes at 160° C., the process is complete after the ceramic tiles cool off.

The protective coating of the after process is one of following: propylene acid resin or propylene acid of styrene epoxy resin complex, or PTFE solution type paint or PVDF/PMMA solution type paint or PVDF/PMMA water-soluble paint; the coarse process also increases the adhesion surface area of the ceramic tiles.

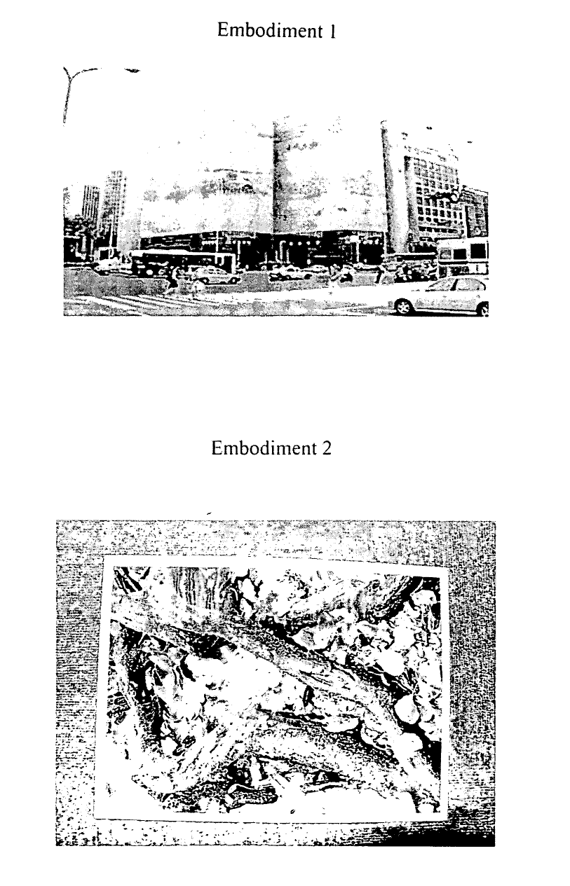

Referring to FIG. 2, the organic and metal basic materials has the same process procedures, the present invention includes following procedures:
1. Choose the basic material: choose the organic such as PVC or metal materials;
2. Pre-process the basic material, the pre-processes include: cleaning, drying, protective coating spraying, standing by, baking, cooling down, surface coarse process, cleaning, drying;
3. Print out graphics with UV printer, print out graphics on basic materials directly; and
4. After process on the surface of basic materials, the after processes include: protective coating spraying, standing by, baking, and cooling down to protect the graphics on the basic materials.

The manufacturing of the metal material, aluminum boards for example, is to clean first and dry, after the drying, spray the preparation covering material for 25˜50μ, stand by for 10 minutes, then bake the aluminum boards at 80° C. for twenty minutes. The protective coating is heat-condense resin, such as phenol resin, alcohol acid resin, polyester resin, amino formic acid ester resin, vinyl resin, propylene acid resin or silicon resin with mineral, the heat-condense resin can increase the scratch-proof of the surface; the coarse process also increases the adhesion of the surface area of the aluminum boards. Cleaning and drying processes proceed after the coarse process to finish the pre-process procedures.

The UV printer can print on those pre-processed aluminum boards, the UV printer applies UV curable ink, the ink dries right alter the illumination of ultraviolet light, the ink can print on any material; the UV printer prints graphics directly on the surface of the aluminum boards.

By this time, the graphics and colors on the aluminum boards are complete, in order to enhance the scratch-proof and weather fastness, after processes are needed; these processes include spraying of protective coating for 25˜50μ; the protective coating of the after process is one of following: propylene acid resin or propylene acid of styrene epoxy resin complex, or PTFE solution type paint or PVDF/PMMA solution type paint or PVDF/PMMA water-soluble paint; after the painting and stand by 10 minutes, then bake 20 minutes at 70° C., the process is done after the aluminum boards are cool.

Following are the test results after the processes of the present invention:
1. Ink and protective coating crosscut test ASTM D 3002 D 3359: class: 5B.
2. Protective coating Pencil Hardness test ASTM D 3363-3H.
3. Protective coating wear-proof test CNS 10784: wear amount under 0.01 g.

Those product manufactured by above processes can apply directly to interior and exterior walls of buildings, as shown in attachment 1 and 2, the graphics can be printed on PVC boards or ceramic tiles, the PVC boards or ceramic tiles are stuck on the interior and exterior walls of buildings for decoration; the PVC boards can be combined with the body of automobiles (bus, train, mass transportation) as advertisement to impress consumers; art creation can also be combined with buildings, such not only show the creation but also makes the artists famous and beautifies the city view, establishes landmark for the city.

Based on above description, the production and manufacturing methods of the present invention have following advantages:
1. Multiple choices, users can choose the best basic material based on environment and actual situation.
2. Digital output does not need plate making, any picture, graphics can be printed out, no limitation of the type of colors, all the colors can be printed on the basic material, effectively shorten the product process and better production efficiency.
3. The pre-process and after process of the present invention can make the pictures and graphics durable with very long weather fastness to support the exterior building requirement.
4. The pre-process and after process of the present invention can make the pictures and graphics more scratch-proof, the integration of the graphics and the basic materials offers the grade in deposit of building materials and exterior boards.
5. The pre-process and after process of the present invention can make the pictures and graphics on the basic materials water-proof.
6. The products manufactured with the present invention not only offers an excellent product package and enterprise image, but also beauties city view, establishes an obvious landmark or a movable sign.

While a preferred embodiment or the invention has been shown and described in detail, it will be readily understood and appreciated that numerous omissions, changes and additions may be made without departing from the spirit and scope of the invention.

What is claimed is:

1. A digital ink jet printing process method comprising following procedures:
1. Choose the basic material, choose the inorganic such as stone, ceramic tiles;
2. Pre-process the basic material, the pre-processes include: cleaning, drying, preparation material covering, baking temperature for said preparation covering material, cooling down, protective coating spraying, standing by, baking, cooling down, surface coarse process, cleaning, drying;
3. Print out graphics with UV printer, print out graphics on basic materials directly; and
4. After process on tile surface of basic materials, the after processes include: protective coating spraying, standing by, baking, and cooling down to protect the graphics on the basic materials.

2. A digital ink jet printing process method comprising following procedures:
1. Choose the basic material, choose the organic such as PVC or metal materials;
2. Pre-process the basic material, the pre-processes include: cleaning, drying, protective coating spraying, standing by, baking, cooling down, surface coarse process, cleaning, drying;
3. Print out graphics with UV printer, print out graphics on basic materials directly; and
4. After process on the surface of basic materials, the after processes include: protective coating spraying, standing by, baking, and cooling down to protect the graphics on the basic materials.

3. The digital ink jet printing process method recited in claim 1, wherein said preparation material is one of following: Neopentyl(diallyl)oxy, tri(dioctyl) pyro-phosphatotitanate, cyclo(dineopentyl(diallyl))pyrophosphato dineopentyl(diallyl) zirconate, neopentyl(diallyl)oxy, zirconate, gamma-aminopropy-ltriethoxysilan, 3-methacryloxypropyltrimethoxysilane, Glycidoxypropyl trimethoxysilane, Hydrolyzed aminoethylaminopropylsilane.

4. The digital ink jet printing process method recited in claim 1, wherein the duration and temperature for said pre-process to process said preparation covering material is 20˜30 minutes and 70° C.˜90° C.

5. The digital ink jet printing process method recited in claim 1, wherein said preparation covering material is one of following heat-condense resin: phenol resin, alcohol acid resin, polyester resin, amino formic acid ester resin, vinyl resin, propylene acid resin or silicon resin with mineral.

6. The digital ink jet printing process method recited in claim 1 or 2, wherein the thickness of said protective coating in said preprocess is 25˜50μ.

7. The digital ink jet printing process method recited in claim 1 or 2, wherein the duration and temperature for said pre-process is 20˜60 minutes and 70° C.˜160° C.

8. The digital ink jet printing process method recited in claim 1 or 2, wherein said protective coating of said after process is one of following: propylene acid resin or propylene acid of styrene epoxy resin complex, or PTFE solution type paint or PVDF/PMMA solution type paint or PVDF/PMMA water-soluble paint.

9. The digital ink jet printing process method recited in claim 8, wherein the thickness of said protective coating is 25˜50μ.

10. The digital ink jet printing process method recited in claim 1 or 2, wherein the duration and temperature for said after process is 20˜60 minutes and 70° C.˜160° C.

11. The digital ink jet printing process method recited in claim 1 or 2, wherein said surface coarse process of said preprocess is done by sand papers.

12. The digital ink jet printing process method recited in claim 1 or 2, wherein said surface coarse process of said pre-process is done by sands.
